(19) United States
(12) Patent Application Publication
(10) Pub. No.: US 2004/0044772 A1
(43) Pub. Date: Mar. 4, 2004

(54) Method and system for controlling admission to a server using temporary server access

(76) Inventor: Arthur S. Harkin, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/231,166

(22) Filed: Aug. 30, 2002

(51) Int. Cl. G06F 15/173

(52) U.S. Cl. 709/227; 709/225

(57) ABSTRACT

A method and system are disclosed for controlling admission to a server. In accordance with exemplary embodiments of the present invention, a request is received from a requestor for admission to the server. Temporary server access to the server is provided to the requester to identify at least one characteristic of the requester. A capacity assessment of the server to service the requestor is determined. Extended server access to the requestor is controlled based on the capacity assessment.

### CROSS-REFERENCE TO RELATED APPLICATION

This application is related to commonly owned, co-pending U.S. patent application Attorney Docket No. 10010452, entitled “Method And System For Controlling Class Of Service Admission To A Server,” which is being concurrently filed herewith, the entire contents of which are hereby incorporated by reference herein.

### BACKGROUND

1. Field of the Invention

The present invention relates generally to network management, and more particularly, to controlling admission to a server.

2. Background Information

Protocols exist in which one computer (e.g., a “host”) receives and processes messages from a number of other computers (e.g., “clients”). For example, the host can be a server that receives and processes concurrent messages from different clients represented as personal computer users.

One or more related messages can be used to designate a session. For example, a multiple-message session can include a message requesting information over the World Wide Web, and an associated response. Alternatively, a multiple-message session can, for example, include a commercial transaction, with related messages being used to locate a web site for a precise product; to submit an order or billing and shipping information; and to convey a confirmation of sale to a particular client.

The term “quality of service” refers to a host's ability to provide a response to a message and to complete a session. For example, due to heavy traffic, a host may not be able to respond to a message at all, or the host may not provide a timely response (which can cause a client to “time-out” and generate an error).

One approach to controlling admission to a server is disclosed in U.S. Pat. No. 6,006,269, entitled “Admission Control System with Messages Admitted or Deferred for Re-submission at a Later Time on a Priority Basis,” to Peter Phaal, the entire disclosure of which is hereby incorporated by reference herein. Exemplary embodiments of the '269 patent are directed to using measurement-based admission control to determine whether a requested web site is available to process a new session. According to an exemplary embodiment, if the site is not available, based upon current resources and defined load parameters, the server-based system determines when the associated server can later provide preferred access to the client, and transmits to the client an indication of that time, together with a key.

Another approach is disclosed in U.S. Pat. No. 6,055,564, entitled “Admission Control Where Priority Indicator is Used to Discriminate Between Messages,” to Peter Phaal, the entire disclosure of which is hereby incorporated by reference herein. Exemplary embodiments of the '564 patent are directed to admission control systems with multiple classes of service and priority processing. In an exemplary embodiment, an admission control system for a given server admits incoming messages which are part of a session in progress. As to messages representing new sessions, the admission control system admits such messages on the basis of a priority or class assigned to them, or otherwise discriminates between messages stored in a message queue based on priority. For example, two different messages may be assigned different status if they are associated with two web sites resident on the server having different levels of available service; as server resources become stretched, the message associated with one of the web sites will receive better quality of service than a message associated with the second web site. For deferred messages, the exemplary admission control system determines when priority access can later be provided to a particular client requesting access to one of the web sites, and transmits to the client an indication of that time.

### SUMMARY OF THE INVENTION

A computer implemented method and system are disclosed for controlling admission to a server using temporary server access. In accordance with exemplary embodiments of the present invention, a request is received from a requestor for admission to the server. Temporary server access to the server is provided to the requestor to identify at least one characteristic of the requestor. A capacity assessment of the server to service the requester is determined. Extended server access to the requester is controlled based on the capacity assessment.

In accordance with an alternate exemplary embodiment of the present invention, a system for controlling admission to a server comprises means for providing, in response to a request for admission to the server by a requester, temporary server access to the server to identify at least one characteristic of a requestor of the request; means for determining a capacity assessment of the server to service the requester; and means for controlling extended server access to the requestor based on the capacity assessment.

In accordance with an alternate exemplary embodiment of the present invention, a computer program product comprises a computer readable medium embodying executable instructions thereon for causing a computer system to control admission to a server. In response to a request for admission to the server, temporary server access to the server is provided to a requester of the request to identify at least one characteristic of the requester. A capacity assessment of the server to service the requester is determined. Extended server access to the requestor is controlled based on the capacity assessment.

### BRIEF DESCRIPTION OF THE DRAWINGS

Other objects and advantages of the present invention will become apparent to those skilled in the art upon reading the following detailed description of exemplary embodiments, in conjunction with the accompanying drawings, wherein like reference numerals have been used to designate like elements, and wherein:

FIG. 1 is a flowchart illustrating exemplary steps for controlling admission to a server; and

FIG. 2 is a block diagram illustrating an exemplary system for controlling admission to a server.

### DETAILED DESCRIPTION OF THE EXEMPLARY EMBODIMENTS

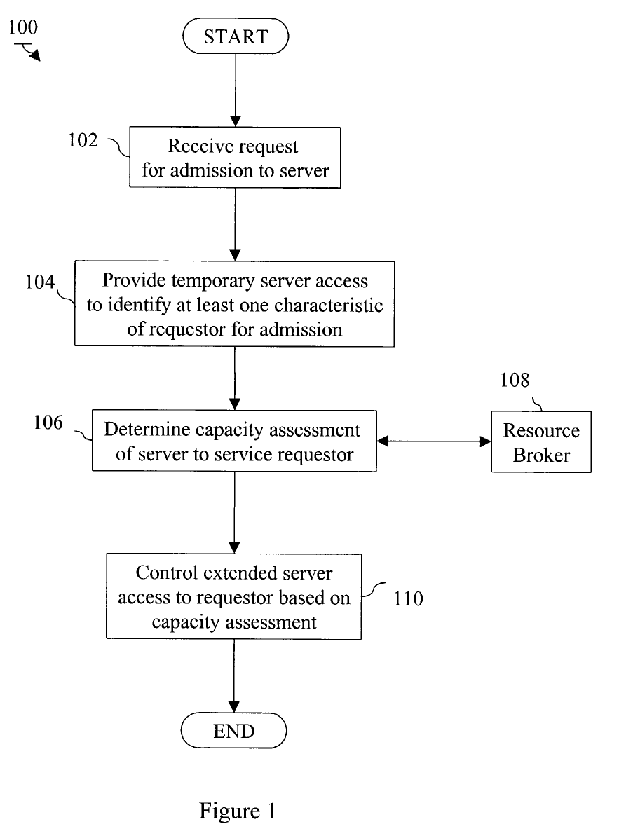

FIG. 1 is a flowchart 100 illustrating steps to be carried out for controlling admission to a server according to an exemplary embodiment of the present invention. After starting, in step 102 of FIG. 1, a request is received for admission to the server.

In step 104 temporary server access is provided to identify at least one characteristic of the requester for admission to the server. The temporary server access can be implemented, for example, as a provisional access which is subject to termination (e.g., at the discretion of a temporary access manager for the server).

Exemplary characteristics of the requestor which can be identified include at least one of a requestor identification (e.g., a “user ID”), and a password corresponding to the requester identification, which can be obtained from the requestor, for example, in a response to a downloaded page requesting requestor information. Another exemplary characteristic of the requestor can include a session identifier which can be classified, for example, by an admission control gateway, as either a “valid session identifier” (e.g., for which a fully admitted session is already in progress) or an “invalid identifier” (e.g., for which there is no prior fully admitted session for the current requestor). The admission control gateway can, under certain conditions described herein, modify the session identifier to indicate that the session should, or has been, afforded temporary (versus full) admission to the server.

An alternate exemplary characteristic of the requestor can be a determination of whether the request for admission to the server is included in a fully admitted session on the server, and/or a determination of whether the request for admission to the server is included in a previously deferred session on the server (e.g., a deferred session as discussed in the '269 patent).

An alternate exemplary characteristic of the requester can be at least one data element including classification information for determining whether the requestor includes a qualification for full server access (e.g., determining whether the requestor is a member of a class of requesters entitled to immediate full server access, assuming the server has available resources to handle another requestor from the class).

An alternate exemplary characteristic of the requester can be a predetermined number of requests for service received from the requester during a period of time corresponding to the temporary server access to the server (e.g., for limiting the number of requests allowed from the requester during the temporary server access). A predetermined period of time measured from a time of the request for admission (e.g., using a temporary start timestamp) to a time of a current request for service from the server, (e.g., using a message received timestamp), can be used to, for example, limit the amount of time allowed for the temporary server access before a decision is made either to fully admit the requester, reject the requester, or provide other admission options (that is, to afford a temporary grace period for evaluating whether the requester should be granted additional access). Alternately, or in addition, a predetermined period of time measured from a time of a first request of service (e.g., a “last” request in time before a current request) from the requester, to a time of a current request for service from the requester can be used. For example, such a temporary grace period can be used to limit the time allowed the requester between consecutive requests during the temporary access. A temporary grace period can also be used for monitoring multiple messages of a requestor until characteristics included in the messages provide enough information for a determination to be made that the requestor should be granted additional access (e.g., full access) to the server.

In step 106 a capacity assessment of the server to service the requester is determined. In an exemplary embodiment, the capacity assessment can be determined using at least one of the characteristics of the requester. For example, if during a temporary grace period, it is determined that the requestor is a member of a class of “premium users” of the server (e.g. users who have paid a premium fee for premium service), then the capacity assessment can be used to determine whether the server has sufficient resources to fully admit another requester in the premium class of service (that is, a premium class of use).

In an exemplary embodiment, the system can optionally be configured to support users at multiple classes of service. Different classes of service can be allocated in any desired manner. For example, requesters can select among different fees for different levels of use and accessibility. The fee structure can be configured to, for example, support premium access for a single message, a single session, for a predetermined period of time, and/or for a period of time delimited by events defined by the requestor meeting agreed terms of premium access (e.g., as long as the required premium access fee is paid and the requester meets all terms of the access offer).

The premium access fee, as with any of the characteristics described herein, can, for example, be encoded in the identification of the requester to the server, and can be used to give the requester a queued access to the server on a first-in first-out basis with respect to any other requestors of the premium class. Alternately, the characteristics can be stored at the server and accessed on behalf of a given requestor. The premium class can, for example, be limited in number to ensure a high probability of immediate servicing. For example, the premium class can be limited to a static number, or can be dynamically limited using a predictive queuing model using any desired policies. Suitable predictive queuing models include, without limitation, those described in “Performance Evaluation And Stress Testing For E-Commerce Systems”, by J. Rolia et al, Abstract for CASCON '98 Demonstration (1998), hereby incorporated by reference in its entirety. Of course, any structure can be used including, but not limited to, the use of attributes other than payment of fees to establish different levels of use.

In an exemplary embodiment, the determination of the capacity assessment includes an assessment of the available resources of the server to service requesters who are provided temporary server access in addition to requestors who are provided fully admitted access to the server. In this exemplary embodiment, if the assessment determines that the server does not have sufficient available resources to service requestors who have already been provided fully admitted access to the server, then the requester can, for example, either be rejected or deferred, as discussed in the '269 patent.

The capacity assessment can be performed by any software, hardware and/or firmware mechanism. In an exemplary embodiment, capacity assessment can be performed by accessing a resource broker 108, to which the server can be coupled either directly (e.g., a resource broker internal to the server) or indirectly (e.g., over a network connection including any wired or wireless connection). A “resource broker” is a hardware, software and/or firmware entity (e.g., a resource broker system) which can determine whether additional resources are available to the server, or whether additional resources can be provisioned to fully admit the requestor. The resource broker 108 can be configured to provide information on current use of server resources. The resource broker 108 can, for example, be configured as a resource monitor discussed in the '269 patent, or in any other suitable manner to achieve the functionality described herein.

The resource broker can also be configured to monitor trends based on statistical analysis of archived use information, for predicting future use. The resource broker can function in accord with any desired allocation and scheduling policies, and these policies can be static and/or dynamically updated. By way of example, and without limitation, resource brokers which can be used are those which are based on a predictive queuing model with associated policies, as well as those available from Mantra (e.g., IRX at www.mantranet.com), Peakstone (e.g., at www.peakstone.com) and others.

In an exemplary embodiment, the system monitors the resources of the server to determine whether the resources are utilized at least to a predetermined threshold percentage of the capacity of the resources (e.g., 80% utilization, or any desired threshold which can be a fixed or adaptive threshold). The system can, for example, determine that no more requesters will be given temporary access to the server. The system can monitor the resources to determine whether the resources become utilized to a more strained level (e.g., 90% utilization), and determine that no more requestors will be given access to the server, as the level of service may become significantly degraded for all requesters of access. At this point, future requesters can be given deferred access, in a manner similar to that disclosed in the '269 patent, but with respect to temporary access. The access can be deferred until it is determined that a particular criterion has been met, such as the percentage, or measurement, of utilization of the resources has decreased, or otherwise changed, to an acceptable level to permit access to more requesters. Alternatively, decisions regarding capacity of the resources can be made by using tables and/or other measurement techniques and/or any user specified inputs.

In step 110, extended server access to the requestor is controlled based in part on the capacity assessment. For example, a determination can be made whether to provide to the requester a fully admitted session on the server based on an identified result for the at least one characteristic of the requester, and/or the requestor can be provided a deferred session on the server.

In processing messages sent for the server, an admission system can be configured to determine whether a particular message is part of a session in progress or is a new request. To track transactions, the system can, for example, maintain and update a transaction list of requests which includes, for example, information on the requestors and sessions. For example, a list of identifications associated with the requesters (that is, actual identifiers of the requesters and/or indirect indicators thereof) can be maintained. The system can maintain an identification of the requester in the form of an identifier provided to the requester for tracking requests (e.g., a cookie written to the requestor) or any other suitable form including, but not limited to, the types of maintenance of tracking information discussed in the '269 patent.

A requested class of use can, in an exemplary embodiment, be either stored or derivable from an indicator within one or more of the requestor's messages, and can be persistent for the duration of the session. A class of use indicator can be explicitly stored as a name value pair in a data structure, such as a cookie that is initially generated by a server and stored on the client for future access by the same or other servers. The cookie can be used to keep state through the client across multiple HTTP requests. A cookie can, for example, include an expiration date, a domain and a path that specifies which servers can receive the cookie from the client. Within the cookie's name=value field, the class of use can be encoded which can be used to derive the class of use. Class of use indicators can alternately include, but are not limited to, encoded URLs, XML tags, and so forth.

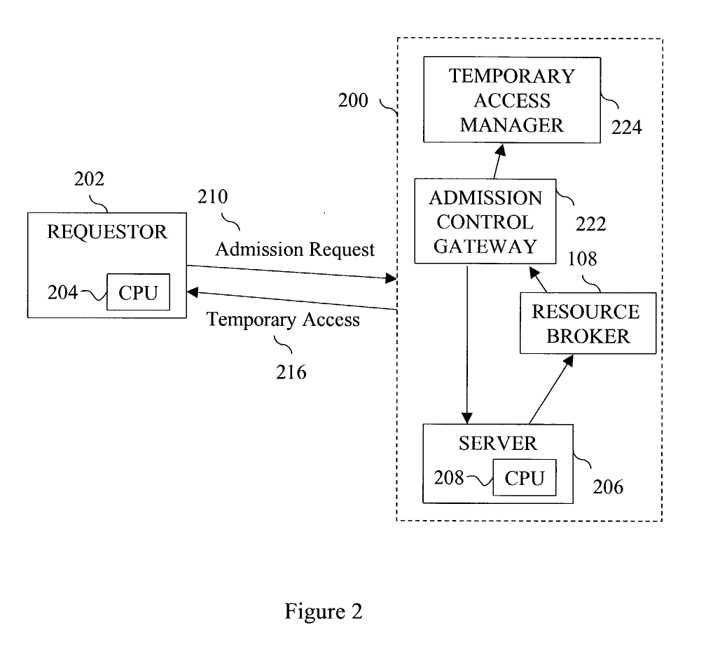

FIG. 2 is a block diagram illustrating an exemplary admission control system 200 for controlling admission to a server 206. A requester 202, which includes any suitable CPU 204, generates an admission request 210 which is received by the admission control system 200. In response to the request, means represented as an admission control gateway 222 and temporary access manager 224 can provide temporary access 216 to the requester 202 to identify at least one characteristic of the requestor 202. In the exemplary FIG. 2 embodiment, the temporary access manager 224, via the admission control gateway 222, accesses a means for determining a capacity assessment of the server for servicing the requester, represented as a resource broker 108 to determine a capacity assessment of the server 206. The server can include a CPU 208, to service the requestor 202 and to control extended server access to the requester based on the capacity assessment.

According to an exemplary embodiment, the admission control gateway can be generally configured in a manner similar to that of the '269 patent, but with its operation optionally modified to change (e.g., modify or append to) the session identifier to indicate that the session has been only temporarily admitted, in accordance with exemplary embodiments of the present invention. The temporary access manager 224 interfaces with the resource broker 108 which assesses the current load on the resources of the server 206, and determines whether the server 206 has a capability to accept the admission request 210. Extended server access to the requester 202 is controlled based on the resulting determination. Exemplary embodiments thus permit a requestor having a selected characteristic, or attributes, such as any of those described in connection with step 104 of FIG. 1, to gain temporary access, and possibly extended access in situations where such access would previously have been denied. For example, the temporary access manager 224 can keep track (e.g., store in memory) any or all of the attributes associated with possible requestors. These attributes can be directly or indirectly embedded in a requestor identification that is either provided by the requestor or obtained by the server for a given requester.

By allowing a requestor temporary access, the temporary access manager can evaluate attributes of the requester and possibly allow the requester immediate, extended access if the requestor possesses certain attributes. For example, the requestor can be evaluated during a temporary admission period, or grace period, to have an associated user ID and password which correspond to a premium (e.g., high priority) class of service for which the requestor has paid a premium, or the requestor can have a particular session identifier that warrants providing the requester full, extended access to the server.

The temporary access manager 224 can be a policy-based manager that implements a set of business logic rules to interpret the current and/or projected resource utilization from the resource broker 108 to determine whether a requestor's 202 admission request 210, that contains no indication of its class of service, should be temporarily admitted to the server. For example, the temporary access manager can monitor a requestor's multiple-message session during this temporary admission period to identify the class of service for the requester 202 using indicators in one or more subsequent messages of the session, and to determine whether the requester should be allowed to continue to access the server.

When the admission control gateway 222 receives an access request and the capacity assessment by class from resource broker 108, the admission control gateway can invoke the temporary access manager with a procedural call (that is, call invocation). An exemplary logic flow of the temporary access manager 224 can include, without limitation, the following steps:

1. Include values for the following variables as part of the call invocation:

a. TEMPORARY_STATUS={REQUESTED, ADMITTED, DENIED}

b. TEMPORARY_START_TIMESTAMP (if previously ADMITTED)

c. MESSAGE_RECEIVED_TIMESTAMP (that is, the time this current message of the session was received by the admission control gateway)

d. SYSTEM_UTILIZATION

2. Evaluate business logic rules in priority order, and stop further evaluation after locating the first business logic rule that evaluates as true; the lowest priority business rule can be a default rule and evaluates as true.

3. Process the business logic rule that was evaluated as true to determine:

a. The TEMPORARY_STATUS (that is, indicate what the admission controller should do with requestor's session)

4. Return to the admission control gateway the values for the following variable:

a. TEMPORARY_STATUS

When processing the business rules, a set of related static business information including, without limitation, values, procedures and formulae is available during the processing of these business rules and can include:

TEMPORARY_GRACE_PERIOD=some relative time interval representing the temporary access period during which a requester is evaluated for extended and/or permanent access; e.g., a length of time measured from when a first message is received by the admission control gateway, and during which subsequent messages from a temporarily admitted session will continue to be admitted.

SYSTEM_THRESHOLD=utilization value

An exemplary set of business rules to complement the previous example logic flow includes the following:

RULE 1. if SYSTEM_UTILIZATION>SYSTEM_THRESHOLD then

a. set TEMPORARY_STATUS=DENIED ; deny even existing temporary sessions; the system threshold can be a server utilization for which new temporary sessions will no longer be admitted

RULE 2. if TEMPORARY_STATUS is ADMITTED then

a. if (TEMPORARY_START_TIMESTAMP+TEMPORARY_GRACE_PERIOD) is less than the MESSAGE_RECEIVED_TIMESTAMP then

i. set TEMPORARY_STATUS=DENIED

RULE 3. set TEMPORARY_STATUS=ADMITTED

In an exemplary embodiment, the admission control gateway can call the temporary access manager when the admission control gateway is not able to determine the class of service identifier. The admission control gateway can use the TEMPORARY_STATUS returned by the temporary access manager to either provide or continue temporary admission to the requestor's session, or if temporary access is to be denied, the admission control gateway can either reject or defer the requestor's session.

The admission control gateway can look for class of service indicators to identify the class of service throughout the temporary admittance of the requestor's multi-message session. For example, multiple messages of and/or responses to the requestor can be examined over the course of the grace period until a message is monitored which directly or indirectly identifies the requestor's class. Once the class of service has been determined by the admission control gateway, the admission control gateway can modify the requestor's session identifier, discontinue calls to the temporary access manager for this requestor's session and perform its own admission control in an exemplary manner similar to that described in the '269 patent.

For a first call to the temporary access manager by the admission control gateway, the admission control gateway can initialize the TEMPORARY_STATUS for this requestor's session to be REQUESTED. When the temporary access manager provides a TEMPORARY_STATUS of admitted for the first time for a requestor's session, the admission control gateway can set a temporary session indicator to be associated with the session that includes a timestamp as to when the session was first temporarily admitted to the server. This timestamp can be passed by the admission control gateway to the temporary access manager in future calls for the same requestor's session.

In these business rules, if the server's utilization is too high, even a requestor's session that was already temporarily admitted can be switched to the status of being denied. This can be prevented if, for example, that session was no longer in a temporary status of admitted, but was already admitted to the server based on a class of service that was determined later by the admission control gateway.

The requestor 202 need not be limited to a single user on a single personal computer (PC), but can include without limitation a server, multiple users or clients on multiple computing devices such as desktop devices, portable devices, handheld devices (e.g., mobile telephones, pagers, personal digital assistants (PDAs)) and/or any other device which can request access to a server. The requestor 202 can also include a software agent implemented in any form of software and/or hardware. For example, a client application can make a request to a host application (i.e., server) for admission, and extended server access can be controlled based on the result of a capacity assessment.

The admission control system 200 can include one or multiple servers servicing multiple users or clients, and can be configured to include an admission control gateway 222 similar to the admission control gateway of the '269 patent, but optionally modified in a manner as described herein. The temporary access manager 224 can make decisions regarding temporary server admission and server admission control for various requesters 202 of admission to the server 206.

To optionally determine whether a particular message is part of a session in progress or is a new request, and track transactions, the admission control gateway 222 and/or the temporary access manager can, for example, be configured to maintain and update a transaction list which includes information used to track the requesters 202 and sessions. This can, for example, be in the form of a list of indicators of identifications associated with the requesters 202 or any other suitable form. The admission control system 200 can optionally maintain the identification of the requestor 202 (e.g., in the form of a cookie written to the requestor 202, or any other suitable form).

A computer program embodying the steps illustrated in FIG. 1 for controlling admission to a server can be embodied in any computer readable medium included in a computer program product for use by or in connection with an instruction execution system, apparatus, or device, such as a computer-based system, processor-containing system, or other system that can fetch the instructions from the instruction execution system, apparatus, or device and execute the instructions. As used herein, a “computer readable medium” can be any means that can contain, store, communicate, propagate, or transport the program for use by or in connection with the instruction execution system, apparatus, or device. The computer program product can be, but is not limited to, an electronic, magnetic, optical, electromagnetic, infrared, or semiconductor system, apparatus, device, or propagation medium or any other suitable medium. Specific examples of the computer program product, without limitation, can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A computer implemented method for controlling admission to a server comprising:
receiving, from a requestor, a request for admission to the server;
providing, to the requester, temporary server access to the server to identify at least one characteristic of the requester;
determining a capacity assessment of the server to service the requestor; and
controlling extended server access to the requester based on the capacity assessment.

2. The method of claim 1, wherein the characteristic of the requester includes at least one of:
of a requestor identification;
a password corresponding to the requester identification;
a session identifier;
a determination of whether the request for admission is included in a fully admitted session on the server;
a determination of whether the request for admission is included in a deferred session on the server;
at least one data element including classification information for determining whether the requester includes a qualification for full server access;
a predetermined number of requests for service by the requestor during a period of time corresponding to the temporary server access to the server;
a predetermined period of time measured from a time of the request for admission to a time of a current request for service by the requester; and
a predetermined period of time measured from a time of a first request for service to a time of a current request for service by the requester.

3. The method of claim 1, wherein determining the capacity assessment of the server comprises:
determining the capacity assessment of the server to service the requestor based on information generated by a resource broker.

4. The method of claim 1, wherein determining the capacity assessment of the server comprises:
determining availability of resources of the server to service at least one fully admitted requestor and at least one temporarily admitted requester.

5. The method of claim 1, wherein controlling extended server access to the requestor comprises at least one of:
providing to the requester a fully admitted session on the server;
determining whether to provide the requestor a fully admitted session on the server based on an identified result for the at least one characteristic of the requester; and
providing to the requester a deferred session on the server.

6. The method of claim 1, comprising:
determining whether the request for admission to the server includes an initial request for service to the server.

7. The method of claim 1, comprising:
providing an identifier to the requestor for tracking requests from the requestor.

8. The method of claim 1, comprising:
updating a list of information used to track requesters and servers.

9. A system for controlling admission to a server comprising:
means for providing, in response to a request for admission to the server by a requester, temporary server access to the server to identify at least one characteristic of a requestor of the request;
means for determining a capacity assessment of the server to service the requester; and
means for controlling extended server access to the requester based on the capacity assessment.

10. The system of claim 9, wherein the at least one characteristic of the requestor includes at least one of:
a requester identification;
a password corresponding to the requestor identification;
a session identifier;
a determination of whether the request for admission is included in a fully admitted session on the server;
a determination of whether the request for admission is included in a deferred session on the server;
at least one data element including classification information for determining whether the requestor includes a qualification for full server access;
a predetermined number of requests for service by the requestor during a period of time corresponding to the temporary server access to the server;
a predetermined period of time measured from a time of the request for admission to a time of a current request for service by the requestor; and
a predetermined period of time measured from a time of a first request for service to a time of a current request for service by the requester.

11. The system of claim 9, wherein the means for determining the capacity assessment receives information generated by a resource broker.

12. The system of claim 9, wherein the means for determining the capacity assessment determines availability of resources of the server to service at least one fully admitted requester and at least one temporarily admitted requestor.

13. The system of claim 9, wherein the means for controlling extended server access to the requestor performs at least one of:
providing to the requester a fully admitted session on the server;
determining whether to provide to a requester a fully admitted session on the server based on an identified result for the at least one characteristic of the requester; and
providing to the requestor a deferred session on the server.

14. The system of claim 9, wherein the determining means determines whether the request for admission to the server includes an initial request for service to the server.

15. The system of claim 9, wherein the controlling means provides an identifier to the requestor for tracking requests from the requestor.

16. A computer program product comprising a computer readable medium embodying executable instructions thereon for causing a computer system to control admission to a server by:
providing, in response to a request for admission to the server by a requestor, temporary server access to the server to identify at least one characteristic of the requestor;
determining a capacity assessment of the server to service the requester; and
controlling extended server access to the requester based on the capacity assessment.

17. The computer program product of claim 16, wherein the characteristic of the requestor includes at least one of:
a requestor identification;
a password corresponding to the requester identification;
a session identifier;
a determination of whether the request for admission is included in a fully admitted session on the server;
a determination of whether the request for admission is included in a deferred session on the server;
at least one data element including classification information for determining whether the requester includes a qualification for full server access;
a predetermined number of requests for service by the requester during a period of time corresponding to the temporary server access to the server;
a predetermined period of time measured from a time of the request for admission to a time of a current request for service by the requester; and
a predetermined period of time measured from a time of a first request for service to a time of a current request for service by the requester.

18. The computer program product of claim 16, wherein the determining the capacity assessment of the server comprises:
determining the capacity assessment of the server to service the requestor based on information generated by a resource broker.

19. The computer program product of claim 16, wherein determining the capacity assessment of the server comprises:
determining availability of resources of the server to service at least one fully admitted requestor and at least one temporarily admitted requestor.

20. The computer program product of claim 16, wherein controlling extended server access to the requestor comprises at least one of:
providing to the requester a fully admitted session on the server;
determining whether to provide the requestor a fully admitted session on the server based on an identified result for the at least one characteristic of the requestor; and
providing to the requester a deferred session on the server.
